(19) United States
(12) Patent Application Publication
(10) Pub. No.: US 2012/0083243 A1
(43) Pub. Date: Apr. 5, 2012

(54) Communication Network Signaling

(76) Inventor: Ari KAHN, Mount Shasta, CA (US)

(21) Appl. No.: 13/287,011

(22) Filed: Nov. 1, 2011

(30) Foreign Application Priority Data
Apr. 30, 2010 (US) PCT/US10/33304

(51) Int. Cl. H04W 4/12; H04W 4/26

(52) U.S. Cl. 455/406; 455/466

(57) ABSTRACT

Short message service (SMS) message processing is described. An SMS message is addressed in a short message entity (SME) device. The SMS message is addressed without providing any message content for the SMS message. The SMS message is sent to an SMS center, and rated based on no message content.

### RELATED APPLICATIONS

This application is a continuation of PCT application PCT/US10/33304, filed Apr. 30, 2010, which claims priority from U.S. provisional application 61/174,889 filed May 1, 2009 the disclosures of which are all incorporated herein by reference.

### TECHNICAL FIELD

This disclosure relates to communication systems and signaling between a message sender and message recipient.

### BACKGROUND

With the introduction of GSM digital based telecommunications systems back in 1991, a number of advanced non-speech services have been provided to mobile subscribers. One such service comprises a Short Message Service (SMS). SMS includes the transmission of short text messages to and from a short message entity (SME). Short message entities can include mobile devices, a fixed line telephone, a fax machine, IP addressable device, or any similar device capable of sending or receiving data or voice communications. For example, using an SMS message, a mobile subscriber can communicate textual messages with another mobile station or SME terminal without establishing a call connection between. In mobile to mobile implementations, a first mobile subscriber simply types the desired text message, indicates the directory number associated with the destination mobile subscriber, and transmits the SMS message encapsulating the desired text message.

Conventionally, SMS messages are typically limited to 160 alpha-numeric characters and contain no images or graphics. Transmitted messages are received by a Short Message Service Center (SMSC) or other device, which is responsible for routing the message to an appropriate device. The SMSC sends a SMS Routing Request to the home location register (HLR) associated with the mobile telecommunication system to find a recipient (e.g., wherever the recipient may be roaming). Responsive to the request, the HLR provides to the SMSC the subscriber's status: inactive or active, and where the subscriber is currently roaming. If the response is “inactive,” then the SMSC will hold onto the message for a period of time. When the subscriber accesses his device, the HLR sends a SMS Notification to the SMSC, and the SMSC will attempt delivery. Conventionally, the SMSC transfers the message in a Short Message Delivery Point to Point format to the MSC associated with the recipient device. The MSC in turns pages the device, and if it responds, the message gets delivered. The SMSC on receiving verification that the message was received by the end user, categorizes the message as “sent” and will not attempt to send again.

While initially, the SMS messaging services were little used, today conventional users including conventional mobile cellular phone users have adopted SMS messaging as an alternative and desirable form of communicating. Billing for messaging can be based on a number factors. Messages can be rated based, for example, on their destination (local international, service platform etc) and charges can be assessed on a message by message basis. Other forms of billing either per message or per time period (e.g., unlimited text messages in a pre-defined billing cycle) that originate and terminate on the home network provider are common. Typically, in at least the North American market, the sender and the recipient of the message are both charged for each message sent. The global billing standard however is sending party pays (Recipients in these systems are typically not charged).

Beeping is a term that is used to describe a process of “signaling” another user on a cellular communication system. A party (the calling party) wishing to signal to another party (the receiving party) can dial the telephone number associated with the receiving party and when the telephone associated therewith starts to ring, can hang up before the recipient answers, generating a “beep” on the called party handset. The hang up results in a missed call being displayed on the handset associated with the receiving party, without generating a billable event for the caller. These generic signals, may be interpreted in any of a number of ways by the called party (e.g., “call me,” “on my way,” “I am home,” “I just landed”) where the “protocol” is typically prearranged between the two parties. This type of communicating has become widespread. Further, the network and communication infrastructure uses significant resources to support these “beeps” with no revenue generation (i.e., the cost of the call set-up, the network usage for creating and completing the signal path to the called party, playing back the ring tone to the calling party etc.). Alternative methods of allowing such communicating in a conventional cellular communication system are desirable, especially if they can result in little or no overhead costs to the communication system providers while allowing the signaling to still occur in as simple a manner.

### SUMMARY

An alternative signaling methodology and attending infrastructure are proposed that allows a user to signal another user in, for example a cellular communication network without engaging the ring. Rather than using valuable system resources in, for example, a synchronous fashion to generate a missed call notification on a recipient handset in the cellular communication network, users can “ping” other users in the network using an all signaling protocol and messaging service that is completed asynchronously without congesting valuable network resources and limited wireless spectrum. In one specific implementation, users can address a message to an intended recipient, provide no message content and then send the empty message to deliver caller line identity to the intended recipient without engaging the ring. The message delivery can result in effectively a same kind of signaling to the recipient (e.g., “call me,” “all ok”) as conventional beeping using a missed call paradigm, without the associated cost to the network. In alternative implementations, a calling party can signal a call recipient by sending a message including addressing the message and providing a standalone signaling code as the message body of the message. The signaling code can be used to provide an experience similar to the beeping experience. The recipient can receive either a message with no content or a message that has been generated by the network that includes pre-formatted message templates that are not specifically entered by the calling party (e.g., a “call me” message is presented as the message body that is provided to the recipient without the user having to type in the message body itself). These “network provided templates” can further instruct the recipient how to similarly “ping” other users in this more efficient manner. This “passing forward with instruction” results in virally adopted service that propagates at “2 to the nth power.” Other example implementations are described further below.

Methods, systems, apparatus and computer program products are provided for processing SMS messages that have purely signaling information or no content. The signaling provided with the message can be used to relay a message between a calling party and a called party with little overhead costs associated with the communication network. Users can be encouraged to no longer beep other users, so as to more efficiently use communication network resources. Users can be encouraged to adopt the alternative form of signaling by any of a number of different methods, ultimately allowing for a transition away from the prior beeping behavior. For example, users can be incentivized to use an SMS ping service as described by highlighting additional benefits. Unlike beeping, the alternate pinging method disclosed delivers an accelerated and guaranteed service. The sender is engaged only momentarily (rather than having to hold the line in order to hear the destination ring) and the recipient is guaranteed to receive the ping, even if unavailable at the time it was sent. These and other advantages can be realized by one or more aspects of the invention.

### DESCRIPTION OF THE FIGURES

FIG. 1 is a block diagram of an example system for delivering SMS messages.

FIG. 2 is a flow diagram for an example method for communicating.

FIG. 3 is a flow diagram for an example method for communicating.

FIG. 4 is a flow diagram for an example method for processing a message.

### DETAILED DESCRIPTION

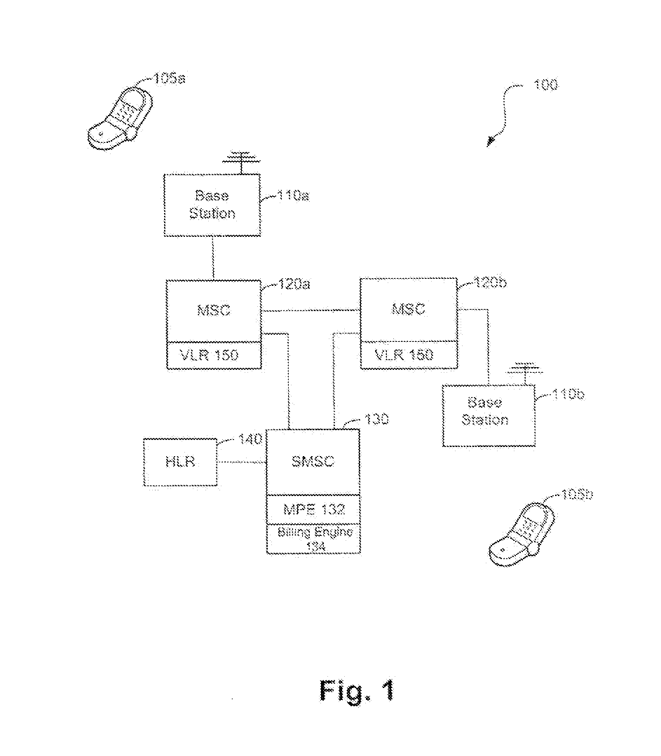

FIG. 1 is a block diagram of an example system 100 for sending short messages in a mobile communication system. Though reference is made to sending messages only in a mobile communication system, messages can be sent to and from other communication systems. For example, messages can be sent from the mobile communication system to a computing system using a mobile data network (e.g., GPRS) or the internet. The system 100 includes one or more short message entity's (SME) 105 including sending mobile terminal 105a and recipient's mobile terminal 105b, first and second base stations 110a and 110b, first and second mobile switching centers (“MSCs”) 120a and 120b, a short message service center (“SMSC”) 130, a home location register (“HLR”) 140 and visitor location register (VLR) 150.

A SME 105 is an entity, which may receive or send messages. In some implementations the SME is a mobile handset that includes both cellular communication capabilities as well as messaging capabilities (e.g., SMS). The SME may be located in a fixed network, a mobile station or another electronic device.

Base stations 110a-b provide wireless network nodes for the sender's mobile terminal 105a and the recipient's mobile terminal 105b, respectively. When receiving a request for sending a short message from the sender's mobile terminal 105a, the first MSC 110a delivers the request to the SMSC 130. The second MSC 110b sends the short message to the recipient's mobile terminal 105b upon receipt of an instruction to send the short message from the SMSC 130. Each base station includes transceivers, which send and receive information over the air interface, to and from the mobile terminals. The information (e.g., a message) is passed over the signaling channels so the mobile can receive messages even if a voice or data call is going on.

Mobile Switching Center (MSC) 120 performs the switching functions of the system and controls calls and message transfer to and from other telephone and data systems. The first MSC 110a is connected to the sender's mobile terminal 105a and to the SMSC 130. The second MSC 110b is connected to the receiver's mobile terminal 105b and the SMSC 130. The MSC 120 and the base station 110 serves as an interface between the SMSC 130 and the sender's and recipient's mobile terminals 105a-b.

Short Message Service Center (SMSC) 130 is responsible for the relaying, storing and forwarding of a short message between an SME's (e.g., between two mobile devices). In the implementation shown, SMSC 130 is also responsible for rating messages and billing functions. Rating, as used herein, refers to evaluating a message to determine either a cost or value associated with the message. Rating can be used to determine charges for completion of delivery of a message (e.g., an SMS message), whom to charge for the delivery (i.e., sender, recipient, or third party sponsor), and value associated with the completed transaction. The rating of messages including the rating of messages with no content or only signaling content included in the message body is discussed in greater detail below. Rating systems are proposed where the SMS traffic is rated based solely on message body signaling or no message content, as opposed to the customary peg count or volume based measure. Further, while the implementation shown indicates that the SMSC is responsible for rating and billing functions, these may be separated or performed by other entities in the communication system. For example, the MSC associated with a mobile handset may be responsible for billing functions. While reference is made to a particular system configuration and particular functions being performed by portions of the system, other configurations and other functional execution scenarios are possible.

Home location register 140 is a database used for permanent storage and management of subscriptions and service profiles. Upon interrogation, the HLR provides the routing information for the indicated subscriber (the recipient mobile terminal). The SMSC 130 interrogates the HLR 140 and receives routing information for the recipient mobile subscriber. The HLR 140 holds information of the subscription profile of the mobile and also about the routing information for the subscriber, i.e., the area (covered by a MSC) where the mobile is currently situated.

Visitor location register 150 is a database that is used for temporary storage and management of visitor mobile station registrations for mobile devices that have temporarily entered into a local associated with an MSC. A VLR corresponds to each MSC and contains temporary information about the mobile, information like mobile identification and the cell (or a group of cells) where the mobile is currently situated. Using information from the VLR the MSC is able to switch the information (e.g., a short message) to the corresponding base station 110, which transmits the short message to the mobile terminal.

In one implementation, the sending mobile terminal 105a includes controller that controls overall operations of the mobile terminal. When a short text message is inputted, the controller encodes the short message and sends it to a specified recipient's address (e.g., as indicated by the recipient's mobile phone number). When the short message is sent to the recipient's mobile terminal, the controller of the recipient's mobile phone receives the short message, decodes it and stores the decoded message in a memory. A display displays the received message.

The display presents the operational state of the mobile terminal and various other information using, for example, icons, short text and images. The display section presents a window for inputting a short text message. The display data corresponding to a key inputted on a key input under the control of the controller (including message address and message body) can be presented to the user of the mobile terminal by the display. A key input section with a plurality of number keys and functions provides key input data to the controller. The controller analyzes the key input data and performs a function according to the data (e.g., sending a message).

A memory connected to the controller can include a ROM (Read Only Memory) and a RAM (Random Access Memory) for storing a plurality of programs and information necessary to control operations of the mobile terminal along with data (e.g., messages, voice commands, address information, call information, message information, terminal information and the like).

An RF section transmits and receives RF signals to and from a base station through an antenna. The RF section converts a received RF signal into an IF (intermediate frequency) signal and outputs the IF signal to a baseband processor. Also, the RF section converts an IF signal inputted from the baseband processor into an RF signal and sends the RF signal to the base station.

A short message is inputted in a message editor under the control of the controller. The message edit section includes a header and a body. The header includes a destination address field for inputting the recipient's mobile phone number (for example, “123 456 7777”). The body includes a message content field for inputting a short text message, no message or a code for signaling the SMSC as will be described in greater detail below. An encoder encodes the short message inputted in the message edit section in an SMS format under the control of the controller. A decoder decodes received short messages from another subscriber's mobile terminal.

Referring again to FIG. 1, SMSC 130 can include a message processing engine 132 and a billing engine 134. Message processing engine 132 receives inbound messages and operates to query an associated MSC to determine a status of a recipient. Message processing engine 132 also manages message delivery and formatting as required. Formatting can include identifying message content to be delivered along with a message as will be discussed in greater detail below. Billing engine 134 processes inbound messages determining a rating for the message and billing. Billing engine 134 coordinates with the HLR to ensure that a message sender is authorized to send messages (e.g., has sufficient credit or has authorization). Billing engine 134 can also rate a received message to determine the cost/value associated with the message and whom to charge (if any) for the transaction. Rating, as disclosed below, can now be based further on whether the message has no content and/or standalone signaling information that forms the entire message body.

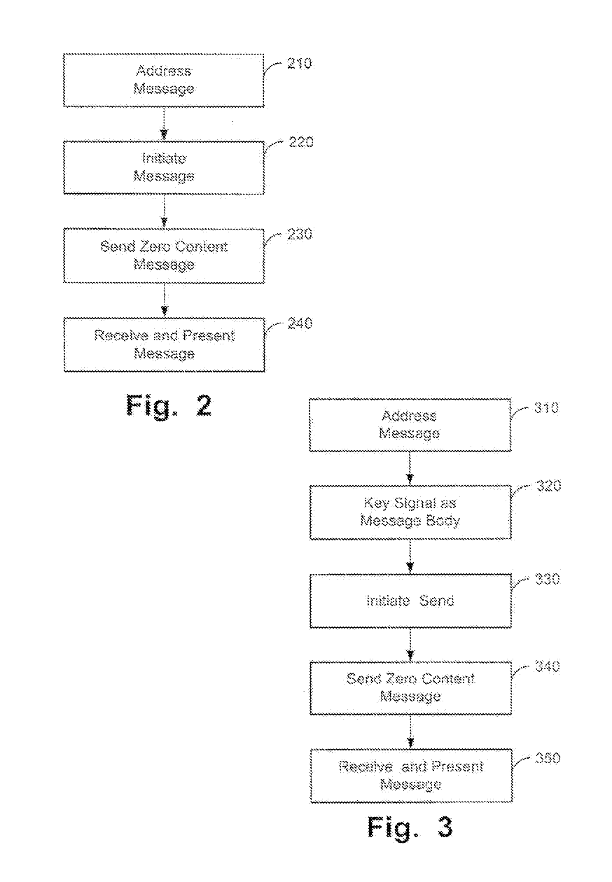

Referring now to FIG. 2, an example method for communicating between a sender and a recipient in a communication network is shown. The method can be executed in part by, for example an SME and one or more other components in a communication network.

At step 210, a sender addresses a message to an address recipient. Addressing can include determining a mobile subscriber telephone number for an intended recipient. The mobile subscriber telephone number can be retrieved from a memory or provided as an input to a key input associated with a message editor or may be automatically provided by the messaging application on selecting reply to a previously received message. Addressing can include initiating a messaging application associated with a mobile communication terminal and inputting the address or otherwise retrieving the address from memory. For example, a sender can initiate an SMS application associated with the sender's mobile device and address an SMS message to an intended recipient using a messaging editor associated with the SMS application.

At step 220, after addressing the message, the sender initiates sending the message. More specifically, without including any message content in a message body portion of the message, the sender initiates a send operation. For example, the user can push a send button associated with a mobile terminal and initiate the transmission of an SMS message to the intended recipient. The user can be prompted to determine if no message content was intended to be sent by the sending application. For example, the messaging application (e.g., SMS application) associated with the mobile terminal can, upon receipt of a send instruction, evaluate a message that is proposed to be sent including determining if no message content is included. If no message content is included, the messaging application can prompt the user to ensure that the send action was not premature or otherwise determine the intent of the sending user. In these implementations, the user can be prompted to verify the zero content message was intended to be sent, and upon verification, can continue the process as detailed below. In some implementations, this verification step is omitted in favor of minimizing the number of keystrokes required for a highly repetitive function. In some implementations, this method permits a user to send a ping when reading a previously received SMS message (stored and accessed in the message inbox) in just two clicks, as in pressing a programmable key that is can be labeled “Reply” and then pressing the same key which is then labeled “Send,” without any additional keyboard input. This double click engagement delivers an richly enhanced user experience over conventional beeping.

At step 230, the zero content message can be sent to the intended recipient. In some implementations, sending can include for zero content messages, bypassing the encoder of the mobile terminal. That is, since no message content is included, the message sent may not be required to be encoded. No encoding saves on local system resources and power consumption. Sending can include delivering an SMS message to the SMSC, determining an MSC associated with an intended recipient, a status check of the availability of the intended recipient, and ultimately delivery of the message to the intended recipient. Sending can also include processing the message, either locally or remotely, including modifying the message to include a predetermined message body as will be discussed in greater detail below. Alternatively, no modifications may be required and the zero content message can be delivered in its basic/simplest form (i.e., with no message content).

At step 240, the zero content message is received and presented to an intended recipient. The presentation to the intended recipient can include presenting a message to the intended recipient with no message content (i.e., presenting a message in a same form as originally sent by the sending terminal). Alternatively, the zero content message can include a pre-determined message body that has been provided by, for example, a network component. For example, a message can be presented to the intended recipient that includes a predetermined message based on a session associated with the sender and recipient. For example, a first message (i.e., a zero content message that includes no content specified by the sending party) sent by a sender to a recipient can be modified to include a message body that includes the message body “call me.” A reply by the message recipient can result in another zero content message transaction where the recipient replies to the original sender with a return zero content message of his own (e.g., merely initiating a reply without providing any message body content). The message application in the recipient's mobile terminal can initiate a reply message that includes no message body. The zero message content reply can in turn be delivered and be modified to include a message body that is provided by some component of the system that includes, for example, a message body “ok asap.”

Other forms of session based message body modification/inclusion in a zero content message transaction are possible. Additionally, empty message body modification and substitution may be determinant on factors such as the time of day the message is sent; the location from which the message is sent; the number of prior ping messages sent and received between the same two parties, and the velocity of message sending. In the latter instance, multiple messages sent in quick succession to the same destination may intelligently aggregate and/or escalate the ping service, by for example incorporating urgency in the message delivered. Service escalation may result in the first empty message delivering an empty message. The second empty message, sent within a specific delta time frame from the first, may result in delivering a “call me” message. The third and fourth messages similarly escalating the communication protocol as in “call me ASAP” and “call me urgently.”

Referring now to FIG. 3, an alternative example method for communicating between a sender and a recipient in a communication network is shown. The method can be executed in part by, for example an SME and one or more other components in a communication network.

At step 310, a sender addresses a message to an address recipient. Addressing can include determining a mobile subscriber telephone number for an intended recipient. The mobile subscriber telephone number can be retrieved from a memory or provided as an input to a key input associated with a message editor or may be automatically provided by the messaging application on selecting “reply” to a previously received message. Addressing can include initiating a messaging application associated with a mobile communication terminal and inputting the address or otherwise retrieving the address from memory. For example, a sender can initiate an SMS application associated with the sender's mobile device and address an SMS message to an intended recipient using a messaging editor associated with the SMS application.

At step 320, a sender keys a signal as a message body associated with the message to be sent. The signal can be of the form of zero message contents. Alternatively, the signal can be of the form of signal code that includes one or more an alpha-numeric characters or symbols. In some implementations, the signal is of the form of a plurality of alpha-numeric characters or symbols. In these implementations, it is desirable to keep the signal length to a minimum to minimize overhead cost associated with sending and processing the message to the intended recipient. In one implementation, the signal code is a message body that includes only the “*” character. In another implementation the signal code is a message body with one or more spaces.

At step 330, after addressing the message, the sender initiates sending the message. More specifically, after including the signal as the message body portion of the message and without providing any other content in the message body, the sender initiates a send operation. For example, the user can push a send button associated with a mobile terminal and initiate the transmission of an SMS message to the intended recipient that includes the signal. The user can be prompted to determine if the signal was intended to be sent by the sending application. For example, the messaging application (e.g., SMS application) associated with the mobile terminal can, upon receipt of a send instruction, evaluate a message that is proposed to be sent including determining if a signal (and nothing more than the signal) is included. If the signal is included, the messaging application can prompt the user to ensure that the send action was not premature or otherwise determine the intent of the sending user. In these implementations, the user can be prompted to verify the zero content message was intended to be sent, and upon verification, can continue the process as detailed below.

At step 340, the zero content message can be sent to the intended recipient. In some implementations, sending can include for zero content messages, bypassing the encoder of the mobile terminal. That is, since no message content is included (i.e., only a signal code is sent), the message sent may not be required to be encoded. No encoding saves on local system resources and power consumption. Sending can include delivering an SMS message to the SMSC, determining an MSC associated with an intended recipient, a status check of the availability of the intended recipient, and ultimately delivery of the message to the intended recipient. Sending can also include processing the message, either locally or remotely, including detecting the signal code and modifying the message to include a predetermined message body as already disclosed. Alternatively, no modifications may be required and the zero content message can be delivered in its basic/simplest form (i.e., with no message content and only the signal code). Alternatively, processing the message can include stripping out the signal code (e.g., if any characters or symbols are included) and forwarding an empty message body message (or other predetermined message body contents) to the intended recipient.

At step 350, the zero content message is received and presented to an intended recipient. The presentation to the intended recipient can include presenting a message to the intended recipient with no message content (i.e., presenting a message in a same form as originally sent by the sending terminal) or only the signal code. Alternatively, the zero content message can include a pre-determined message body that has been provided by, for example, a network component. For example, a message can be presented to the intended recipient that includes a predetermined message based on a session associated with the sender and recipient. For example, a first message (i.e., a zero content message that includes no content specified by the sending party) sent by a sender to a recipient can be modified to include a message body that includes the message body “call me.” A reply by the message recipient can result in another zero content message transaction where the recipient replies to the original sender with a return zero content message of his own (e.g., merely initiating a reply without providing any message body content). The message application in the recipient's mobile terminal can initiate a reply message that includes no message body. The zero message content reply can in turn be delivered and be modified to include a message body that is provided by some component of the system that includes, for example, a message body “ok asap.” Other forms of session based message body modification/inclusion in a zero content message transaction are possible.

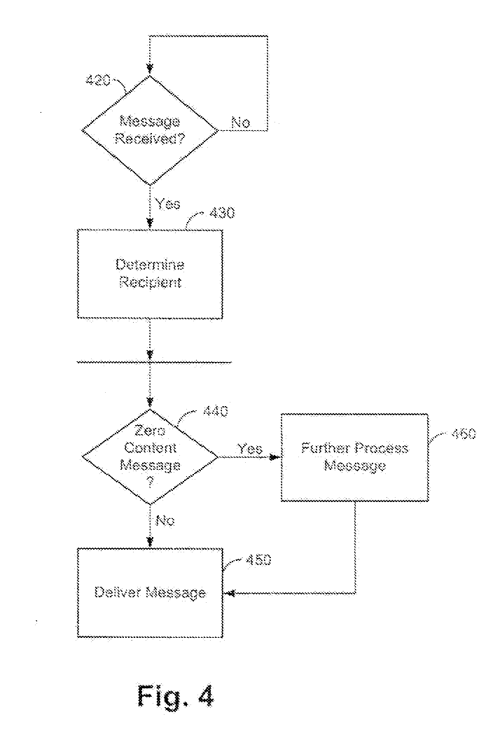

Referring now to FIG. 4, an example method for processing a message from a sender is provided. The method can be executed by, for example, the SMSC in a communication network. The communication network can be a cellular communication network that includes communication channels for communicating voice content as well as messages (e.g., SMS messages). Other communication networks are possible as well as other forms of messaging systems.

At step 410, a determination is made that a message has been received. For example, the SMSC can determine whether a short (SMS) message has been received from the sender's mobile phone. If no message is received, then the process can continue in a stand by mode (step 420) waiting for a message to be delivered (e.g., waiting for a message to be sent from the sender's mobile phone).

At step 430, if a short message is received, a header of the message is searched to determine an intended recipient. For example, the SMSC can search the header of the received short message. As previously explained, the header includes the destination address field (e.g., the mobile terminal subscriber telephone number).

At step 440, a determination is made whether the message received is a zero content message. For example, a determination can be made whether the received message has no message content or a signal code is included as the message body of the received message (e.g., no other message content is included). For example, the SMSC can detect there is no message content. Alternatively, the SMSC can compare the message content to a stored signal code. The stored signal code can be stored locally or retrieved from a remote service. If the stored signal code matches the message body contents, then a positive determination is made.

If at step 440, no zero content message is detected, then the process continues at step 450 where the message is delivered to the intended recipient. Delivery, as discussed above can include determining an MSC associated with one or more of the sender and the intended recipient, determining a status of the intended recipient, storing the message, formatting the message and ultimately delivering the message to an associated MSC for delivery to the mobile terminal associated with the intended recipient.

If at step 440 a determination is made that the message is a zero content message, then the message is further processed at step 460. In step 460, the message is rated. The rating can be based on the zero content message, and not, for example based on the peg count or message volume. Rating can be performed, for example by the SMSC. Alternatively, rating can be by another component within the communication network. Rating can include a determination of whom to charge for the message transmission (e.g., a sender, a recipient, or a third party sponsor). Rating can also include how much to charge a party. In some implementations, sending zero text messages can result in a reduced message cost (e.g., a conventional message can be charged at 10 cents, while a zero message content message can be charged at 1 cent). To effectively replace the beeping phenomenon (ringing and disconnecting prior to call answer and which as such has no billing associated with the event), pinging using the empty message and signal code method disclosed can be similarly “zero rated” (that is the message is accepted and delivered by the network at, in some implementations, no cost to the sender and receiver). Rating can also include authorization and velocity checks (e.g., determining if too many zero content messages have been sent by the subscriber in a given period). Rating can as well include billing functions, where a determined payee is billed for the message transmission.

After rating, the message can be delivered at step 450.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal, that is generated to encode information for transmission to suitable receiver apparatus for execution by a computer. The computer readable medium can be a machine readable storage device, a machine readable storage substrate, a memory device, a composition of matter affecting a machine readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
addressing a short message service (SMS) message in a short message entity (SME) device;
without providing any message content for the SMS message, sending the SMS message to an SMS Center; and
rating the SMS message based on no message content.

2. The method of claim 1 where the SME device is a mobile handset.

3. The method of claim 1 further comprising responsive to receipt of the SMS message at the SMS Center, delivering a SMS message with a predetermined message content to an intended recipient of the SMS message, wherein the predetermined message content is not specified by a sending party.

4. The method of claim 3 where delivering a message further includes determining a message body to be included in the SMS message to be delivered to the message recipient, and adding the message body to a message addressed to the message recipient and delivering the message including the predetermined message body to the message recipient.

5. The method of claim 1 further comprising charging a message sender a reduced amount for sending a message with no message content.

6. The method of claim 5 further comprising charging the message sender nothing for sending the message with no message content.

7. The method of claim 1 further comprising forwarding the SMS message to a Mobile Switching Center (MSC) associated with a location of the message recipient and delivering the message to the message recipient.

8. The method of claim 1 where the step of without providing any message content for the SMS message includes providing only a signal code as a message body of the SMS message.

9. The method of claim 8 wherein the signal code is a text character and where the text character is not delivered to a message recipient.

10. The method of claim 8 where the signal code is one or more text characters or symbols.

11. The method of claim 1 where the SME device is a computer.

12. The method of claim 1 where an intended recipient is a mobile device.

13. The method of claim 1 where both the SME device and the intended recipient are mobile devices.

14. The method of claim 1 further comprising transmitting the SMS message to the SMS Center without a message body.

15. The method of claim 1 where addressing includes addressing the SMS message to an intended recipient.

16. A method comprising:
addressing a short message service (SMS) message in a short message entity device; and
adding a signaling code to a message body of the SMS message and not providing any other content in the message body;
sending the SMS message to an SMS Center; and
rating the SMS message based on no additional message content.

17. The method of claim 16 where the SME device is a mobile phone.

18. The method of claim 16 further comprising rating the SMS message based on the signaling code.

19. The method of claim 16 further comprising responsive to receipt of the SMS message at the SMS Center, delivering a SMS message with a predetermined message content to an intended recipient of the SMS message, wherein the predetermined message content is not specified by a sending party.

20. The method of claim 19 where delivering a message further includes determining a message body to be included in the SMS message to be delivered to the message recipient, and adding the message body to a message addressed to the message recipient and delivering the message including the predetermined message body to the message recipient.

21. The method of claim 16 further comprising charging a message sender a reduced amount for sending a signaling message code with no additional message content.

22. The method of claim 21 further comprising charging the message sender nothing for sending a signaling message code with no message content.

23. The method of claim 16 further comprising forwarding the SMS message to a Mobile Switching Center (MSC) associated with a location of the message recipient and delivering the message to the message recipient.

24. The method of claim 16 where the step of providing a signaling code includes providing a text character and where the text character is not delivered to a message recipient.

25. The method of claim 16 where the step of providing a signaling code includes providing a plurality of text characters or symbols as the message body.

26. A method comprising:
rating a text message based on no content provided with the text message.

27. The method of claim 26 where rating includes determining a cost to charge for the SMS message.

28. The method of claim 26 where rating includes determining a party to charge for the SMS message.

29. The method of claim 26 where rating includes determining a value to attribute for the SMS message.

30. A method comprising:
rating a text message based on a signaling code included as a body of the text message.

31. The method of claim 30 where rating includes determining a cost to charge for the SMS message.

32. The method of claim 30 where rating include determining a party to charge for the SMS message.

33. The method of claim 30 where rating includes determining a value to attribute for the SMS message.
